(19) United States
(12) Patent Application Publication
(10) Pub. No.: US 2024/0083077 A1
(43) Pub. Date: Mar. 14, 2024

(54) MULTI-NOZZLE ADDITIVE MANUFACTURING

(71) Applicant: INTERNATIONAL BUSINESS MACHINES CORPORATION, ARMONK, NY (US)

(72) Inventors: Alan Chung, Hopewell Junction, NY (US); Jeremy R. Fox, Georgetown, TX (US); Martin G. Keen, Cary, NC (US); Sarbajit K. Rakshit, Kolkata (IN)

(21) Appl. No.: 17/930,435

(22) Filed: Sep. 8, 2022

(51) Int. Cl. B29C 33/38; B29C 64/106; B29C 64/209; B33Y 10/00; B33Y 30/00; B33Y 99/00

(52) U.S. Cl. CPC B29C 33/3842; B29C 64/106; B29C 64/209; B33Y 10/00; B33Y 30/00; B33Y 99/00

(57) ABSTRACT

Described are mechanisms for multi-nozzle additive manufacturing. The mechanisms include a three-dimensional printer including a primary print head with a primary nozzle. The three-dimensional printer further includes a nozzle print head configured to print different nozzles for additive manufacturing of an object. The three-dimensional printer further includes a secondary nozzle printed by the nozzle print head, and the three-dimensional printer is configured to print the object using the primary print head, the primary nozzle, and the secondary nozzle.

### BACKGROUND

The present disclosure relates to additive manufacturing, and, more specifically, to creating and using multiple nozzles for additive manufacturing.

Additive manufacturing includes manufacturing techniques such as three-dimensional (3D) printing. In 3D printing, material is deposited layer-by-layer to create a component. 3D printing can be useful in applications such as prototype manufacturing and custom manufacturing of any number of parts. Further, 3D printing can be useful in applications requiring unique, delicate, complex, and/or interior geometries that are more efficient to manufacture using 3D printing than other manufacturing techniques.

### SUMMARY

Aspects of the present disclosure are directed toward a three-dimensional printer comprising a primary print head with a primary nozzle. The three-dimensional printed further comprises a nozzle print head configured to print different nozzles for additive manufacturing of an object. The three-dimensional printer further comprises a secondary nozzle printed by the nozzle print head, where the three-dimensional printer is configured to print the object using the primary print head, the primary nozzle, and the secondary nozzle.

Additional aspects of the present disclosure are directed toward a computer-implemented method comprising determining multiple nozzles for performing additive manufacturing of an object. The method further comprises printing, using a nozzle print head of a three-dimensional printer comprising a primary print head with a primary nozzle and the nozzle print head, a secondary nozzle. The method further comprises printing the object using the primary print head, the primary nozzle, and the printed secondary nozzle.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example three-dimensional (3D) printer implementing multi-nozzle printing, in accordance with some embodiments of the present disclosure.

FIG. 2 illustrates a block diagram of an example print head, in accordance with some embodiments of the present disclosure.

FIG. 3A illustrates a flowchart of an example method for multi-nozzle 3D printing, in accordance with some embodiments of the present disclosure.

FIG. 3B illustrates a flowchart of an example method for exchanging nozzles during multi-nozzle 3D printing, in accordance with some embodiments of the present disclosure.

FIG. 4A illustrates a flowchart of an example method for training a machine learning model for multi-nozzle 3D printing, in accordance with some embodiments of the present disclosure.

FIG. 4B illustrates a flowchart of an example method for correcting a printing error, in accordance with some embodiments of the present disclosure.

FIG. 5 illustrates a flowchart of an example method for downloading, deploying, metering, and billing usage of multi-nozzle additive manufacturing code, in accordance with some embodiments of the present disclosure.

FIG. 6 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward additive manufacturing, and, more specifically, to creating and using multiple nozzles for additive manufacturing. While not limited to such applications, embodiments of the present disclosure may be better understood in light of the aforementioned context.

Additive manufacturing (also referred to as three-dimensional (3D) printing) involves receiving a computer-aided design (CAD) model, parsing the CAD model into numerous layers, and then printing each layer sequentially to physically manufacture a component based on the CAD model. The printing can function by any number of techniques and processes that are configured to fuse, join, or otherwise combine material. For example, 3D printing can be performed by fused-filament fabrication (FFF), vat photopolymerization, material jetting, binder jetting, powder bed fusion, material extrusion, directed energy deposition, sheet lamination, and/or other 3D printing techniques.

A variety of materials can be used in manufacturing. These materials can include thermoplastics that are heated to a flowing point, deposited according to the layer-by-layer deposition protocol, and allowed to cool to solidify and bind with any adjacent material. In some situations, multiple materials are used, or similar materials are used with different modifiers, reinforcements, and/or fillers for color, strength, magnetism, and/or other customized aesthetic or structural properties.

3D printers utilize a nozzle to deposit material to fabricate components. Nozzles can be engineered to balance versatility (e.g., the ability to print with a variety of materials) with performance (e.g., the ability to print high-resolution parts). For example, a relatively larger nozzle orifice can deposit more material in a single pass, thus increasing the speed at which a component can be printed. However, the larger the nozzle orifice, the less detailed the printed component (i.e., component resolution). Such tradeoffs can lead to inefficiencies in printing speed and/or limitations in printing quality.

Aspects of the present disclosure are directed to addressing the aforementioned tradeoffs by utilizing multi-nozzle printing. More specifically, aspects of the present disclosure can utilize multiple nozzles to print a component, where at least one of the multiple nozzles is printed by the 3D printer. The printed nozzle can have different characteristics than the primary nozzle such as, for example, a different orifice geometry, a different internal geometry, a different external geometry, and the like. The printed nozzle can be customized to complement the primary nozzle for the component being printed. In this way, the printed nozzle can be tailored to uniquely facilitate more efficient and/or higher-quality printing than would be achieved by the primary nozzle alone for the component being printed.

Advantageously, multi-nozzle printing can increase printing efficiency and/or quality. Printing efficiency can be increased by utilizing a nozzle with a relatively larger orifice, for example. Printing quality can be increased by utilizing a nozzle with a relatively smaller orifice capable of higher-resolution printing, for example. In some embodiments, printing quality can be increased by a unique external and/or internal geometry for depositing material at hard-to-reach portions of a complex geometry, as another example.

Collectively, these aspects of the present disclosure can enable printing of otherwise unprintable components (when limited to the usage of a single, pre-existing, primary nozzle). In this way, aspects of the present disclosure can be beneficial for prototype fabrication. As another example, aspects of the present disclosure can enable faster printing of a component in a production run, where the time spent printing the secondary nozzle(s) is quickly made up by the time saved in fabricating each component. In this way, aspects of the present disclosure can be beneficial for traditional manufacturing applications.

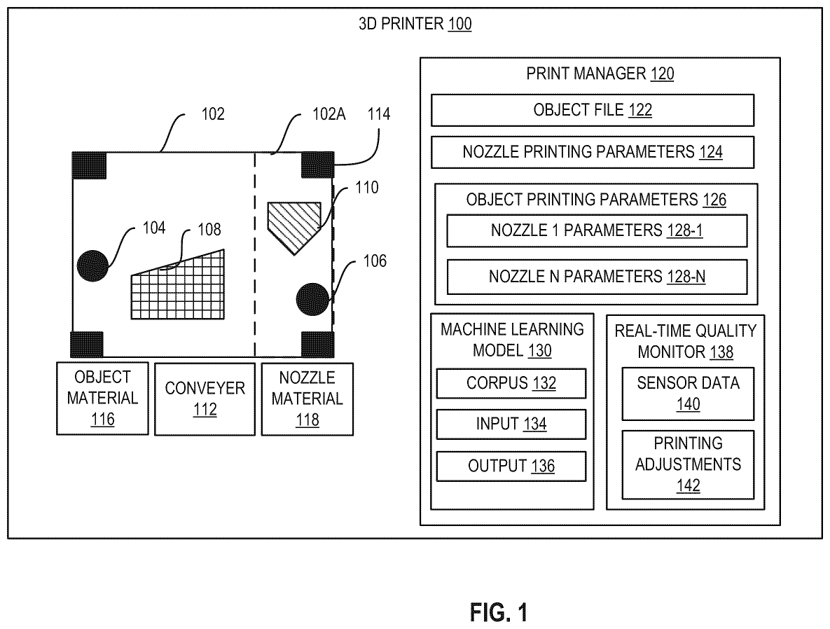

Referring now to the figures, FIG. 1 illustrates a block diagram of a top view of an example 3D printer 100, in accordance with some embodiments of the present disclosure. 3D printer 100 includes a platform 102 upon which an object 108 is created using layer-by-layer deposition of object material 116 from a print head 104. The print head 104 can be configured to deposit object material 116 at a predetermined feed rate using multiple, interchangeable nozzles (e.g., each with a unique orifice geometry, internal geometry, and/or external geometry) with one or more predetermined backpressures and one or more predetermined temperatures. The print head 104 can articulate in three dimensions using, for example, a ball-and-socket where the print head 104 is attached by an extendable and retractable arm and may move about platform 102 in all three dimensions. In another example, the print head 104 can move in three dimensions using a track system whereby, for example, the track moves forward and backward in the y-direction, the print head 104 traverses the track in the x-direction, and the track extends and retracts in the z-direction. These are only examples of print head 104, and print head 104 can include any print head architecture and articulating apparatus now known or later developed.

3D printer 100 can further include a nozzle print head 106, which can be similar in nature to print head 104. Nozzle print head 106 can be configured to create, by additive manufacturing, at least one secondary nozzle 110. Secondary nozzle 110 can be interchangeable with a nozzle on the print head 104 so that the print head 104 can utilize multiple nozzles while creating object 108. Nozzle print head 106 can utilize a portion 102A of platform 102 that is dedicated for manufacturing the secondary nozzle 110. In other embodiments, nozzle print head 106 can utilize a separate platform from platform 102. In some embodiments, nozzle print head 106 can print secondary nozzle 110 concurrently with the print head 104 printing a part of the object 108 (e.g., a portion of the object 108 that does not require the secondary nozzle 110). The nozzle print head 106 can create the secondary nozzle 110 using nozzle material 118. Nozzle material 118 can be a material exhibiting a higher melting point than the object material 116 so that the secondary nozzle 110 does not degrade while performing layer-by-layer deposition of object material 116 to form object 108.

Object material 116 and nozzle material 118 can include any type of material suitable for additive manufacturing. Some non-limiting examples can include acrylonitrile butadiene styrene (ABS), thermoplastic elastomers (TPEs), thermoplastic urethanes (TPUs), poly-lactic acid (PLA), polystyrene (PS), high-impact polystyrene (HIPS), polyethylene (PE), polyethylene terephthalate (PET), polyethylene terephthalate glycol-modified (PETG), polypropylene (PP), nylon, acrylonitrile styrene acrylate (ASA), polycarbonate (PC), polyvinyl alcohol (PVA), and others. In some embodiments, object material 116 and/or nozzle material 118 can include a combination of two or more materials (e.g., a composite, a polymer blend, etc.). Although not explicitly shown, the object material 116 and/or the nozzle material 118 can include any number of additives useful for improving processability, improving longevity, and/or improving mechanical, electrical, or temperature properties. For example, the object material 116 and/or the nozzle material 118 can include plasticizers, nucleating agents, desiccants, impact modifiers, chain extenders, stabilizers, carboxyl scavengers, fillers (e.g., mineral, wood, metal, aramid, carbon, graphite, etc.), and the like. In some embodiments, object material 116 and/or nozzle material 118 include reinforcement (e.g., short-fiber reinforcement, long-fiber reinforcement, continuous fiber reinforcement, etc.). Reinforcements can include, for example, carbon fiber, aramid fiber, and/or other types of natural or artificial fibers, now known or later developed.

3D printer further includes conveyer 112 for exchanging the secondary nozzle 110 with a nozzle of the print head 104. The conveyer 112 can be any electro-mechanical apparatus capable of automatically retrieving the secondary nozzle 110 from the portion 102A of the platform 102, transporting the secondary nozzle 110 to the print head 104, removing a nozzle from the print head 104, and attaching the secondary nozzle 110 to the print head 104. In some embodiments, the conveyer 112 utilizes mechanisms previously discussed with respect to print head 104 to navigate the platform 102. The conveyer 112 can further include fixturing capable of detaching a nozzle from pint head 104 and attaching the secondary nozzle 110 to the print head 104. Alternatively, the secondary nozzle 110 can be retrofitted onto a nozzle already on the print head 104. In such embodiments, the conveyer 112 can transport the secondary nozzle 110 to the print head 104 and retrofit the secondary nozzle 110 over a nozzle of the print head 104.

Any number of fixturing methods, now known or later developed, can be utilized for detaching and attaching nozzles to print head 104. For example, fixturing methods can include threading, mechanical interlocking, clasping, screwing, retaining, or otherwise affixing secondary nozzle 110 to print head 104. In some embodiments, magnets can be used to support or perform the affixing.

3D printer 100 further includes sensors 114 proximate to the platform 102 for monitoring fabrication of the object 108. The sensors 114 can be, for example, cameras collecting optical data, lasers collecting distance data (which can be used to generate a 3D representation of the object 108 as it is being printed), and/or other sensors. Although four sensors 114 are shown in corners of platform 102, more or fewer sensors 114 in similar or different locations fall within the spirit and scope of the present disclosure.

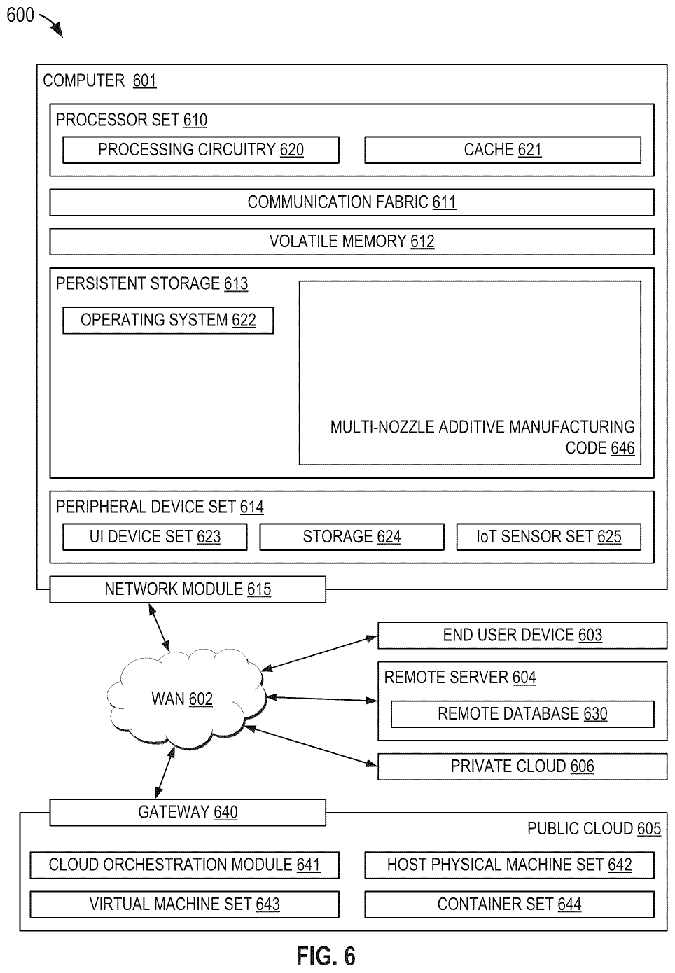

3D printer 100 further includes print manager 120. Print manager 120 is a combination of hardware and software configured to control print head 104 to print object 108, nozzle print head 106 to print secondary nozzle 110, and conveyer 112 to exchange nozzles on print head 104. In some embodiments, print manager 120 utilizes data from sensors 114 to provide real-time printing adjustments 142 while the object 108 is being printed. Print manager 120 can be implemented as code executing on hardware (e.g., multi-nozzle additive manufacturing code 646 described hereafter with respect to FIG. 6).

Print manager 120 can include an object file 122, nozzle printing parameters 124, object printing parameters 126, machine learning model 130, and real-time quality monitor 138. Object file 122 can be, for example, a CAD model of the object 108 that is stored in, for example, a stereolithography (STL) file format. Object file 122 can include information related to dimensions, tolerances, features, materials, and the like.

Print manager 120 further includes nozzle printing parameters 124 and object printing parameters 126. Nozzle printing parameters 124 can relate to parameters for printing secondary nozzle 110 and object printing parameters 126 can relate to parameters for printing object 108. Nozzle printing parameters 124 and object printing parameters 126 can include nozzle information and material information useful for performing printing. For example, nozzle information can include, but is not limited to, nozzle speed, nozzle feed rate, nozzle back pressure, nozzle temperature, nozzle path, and/or nozzle orifice size and/or geometry.

Material information can include, but is not limited to, material properties for one or more object materials 116 and/or nozzle materials 118 such as a material type, a material melting point, a material glass transition temperature, a rheological profile of the material (e.g., viscosity, viscosity as a function of shear rate, etc.), a material elasticity profile as a function of temperature, and the like. A material melting point can be useful for defining nozzle temperature. A rheological profile of the material can be useful for defining nozzle feed rate, nozzle back pressure, and/or nozzle orifice size and/or geometry.

Object printing parameters 126 further includes specific parameters assigned to specific nozzles of a plurality of nozzles such as nozzle 1 parameters 128-1 and nozzle N parameters 128-N (where N is any integer representing any number of nozzles used in print head 104 to print the object 108). Nozzle 1 parameters 128-1 can refer to printing parameters for a first nozzle on print head 104 and nozzle N parameters 128-N can refer to printing parameters for a secondary nozzle 110 that is exchanged with the first nozzle on print head 104 during printing of the object 108. Nozzle parameters 128 can define which portions of object 108 will be printed by each nozzle of N nozzles.

In some embodiments, nozzle printing parameters 124 and/or object printing parameters 126 are manually defined based on user input. In other embodiments, nozzle printing parameters 124 and/or object printing parameters 126 are automatically defined using one or more automated algorithms and/or databases. In yet other embodiments, nozzle printing parameters 124 and/or object printing parameters 126 can be automatically generated by machine learning model 130.

Machine learning model 130 can be based on a corpus 132 of data related to usage of multiple nozzles in printing various objects. Machine learning model 130 can comprise algorithms or models that are generated by performing supervised, unsupervised, or semi-supervised training on a dataset, and subsequently applying the generated algorithm or model to predict nozzle printing parameters 124 and/or object printing parameters 126.

Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Machine learning model 130 can be trained using corpus 132. The machine learning model 130 can then receive input 134. Input 134 can be, for example, object file 122, information related to print head 104 (e.g., an existing nozzle geometry on print head 104), information related to object material 116, and/or information related to nozzle material 118. The machine learning model 130 can generate output 136 in response to receiving the input 134. The output 136 can comprise, for example, nozzle printing parameters 124 and/or object printing parameters 126. Thus, output 136 can be used to print the secondary nozzle 110 and utilize at least a primary nozzle and the secondary nozzle 110 to print the object 108.

Print manager 120 can further include real-time quality monitor 138 including sensor data 140 and printing adjustments 142. Real-time quality monitor 138 can be configured to measure accuracy of the object 108 as it is printed relative to the specifications of the object (e.g., as stored in the object file 122). Sensor data 140 can be received from one or more sensors 114 and can be used to compare a progress of printing the object 108 to the object file 122 for determining if there are any out-of-tolerance features and/or degraded/mis-printed features of the partially printed object 108. The sensor data 140 can then be used to generate printing adjustments 142. Printing adjustments 142 can modify nozzle printing parameters 124, object printing parameters 126, and/or movement coordinates for print head 104 and/or nozzle print head 106.

The configuration illustrated in FIG. 1 is an example configuration, and it should not be construed as limiting. For example, although FIG. 1 illustrates print manager 120 incorporated into the 3D printer 100, in other embodiments, the print manager 120 (or a portion of print manager 120) can be communicatively coupled to the 3D printer 100 via a network. In such embodiments, features of the invention can be delivered to the 3D printer 100 as a service. Further, although 3D printer 100 is shown having two print heads (e.g., print head 104 and nozzle print head 106), in other embodiments, a single print head can be used to print both nozzles (e.g., using nozzle material 118) and objects (e.g., using object material 116). Further, although 3D printer 100 is shown as using a recently printed secondary nozzle 110, in other embodiments, the 3D printer 100 retrieves a previously printed nozzle from a repository of nozzles to perform multi-nozzle printing of object 108. As yet another example alternative configuration, although the 3D printer illustrates print head 104 dedicated for printing object 108 and nozzle print head 106 dedicated for printing secondary nozzle 110, in other embodiments, both (or more than two) print heads can be used in conjunction for simultaneously printing object 108 and/or secondary nozzle 110.

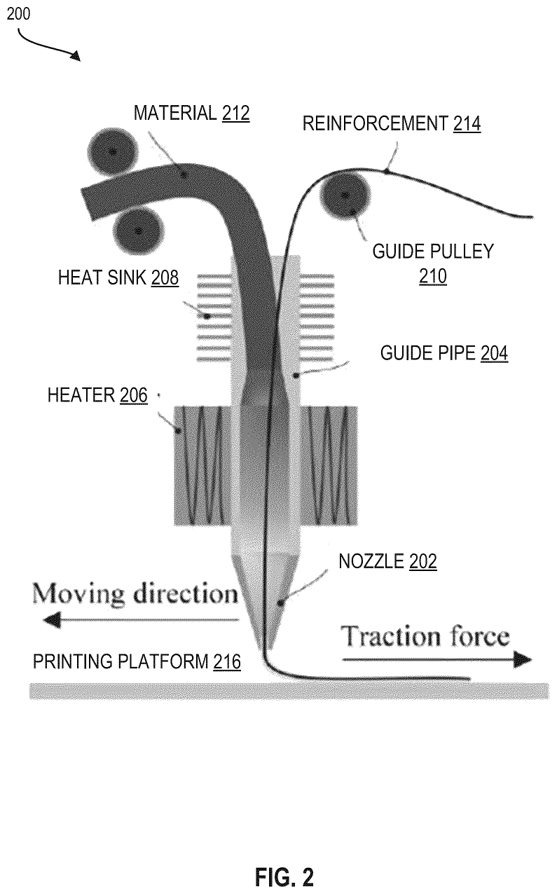

FIG. 2 illustrates a block diagram of an example print head 200, in accordance with some embodiments of the present disclosure. Print head 200 can be consistent with print head 104 and/or nozzle print head 106 of FIG. 1. Print head 200 includes a nozzle 202 for directing material 212 (optionally including reinforcement 214) onto a printing platform 216. The nozzle 202 can exhibit a moving direction and a traction force, where the traction force can be a function of a surface roughness of the printing platform 216, a distance between the nozzle 202 and the printing platform 216, a speed of nozzle 202 moving in the movement direction, and/or characteristics of material 212 (optionally with reinforcement 214) such as viscosity, rheology, and the like. Print head 200 can include a heater 206 for heating the material 212 into a malleable state (e.g., liquid, molten, etc.). Print head 200 can further include a heat sink 208 above the heater 206 for isolating heating of the material 212 to a selected portion of the print head 200 near the nozzle 202. In this way, the print head 200 reduces excessive melting of material 212 that would degrade the ability of the print head 200 to feed material 212 through the guide pipe 204 and into the nozzle 202. Print head 200 further includes pulleys such as guide pulley 210 for guiding reinforcement 214 into the guide pipe 204.

In some embodiments of the present disclosure, nozzle 202 is interchangeable such that nozzle 202 can be removed from guide pipe 204 and a new nozzle (e.g., secondary nozzle) can be affixed to guide pipe 204. In other embodiments, a new nozzle can be retrofitted onto the nozzle 202 to alter an orifice geometry of the nozzle 202 without requiring a full exchange of a first nozzle for a second nozzle. Regardless of the mechanism used, multi-nozzle printing can increase efficiency and/or quality of 3D printing.

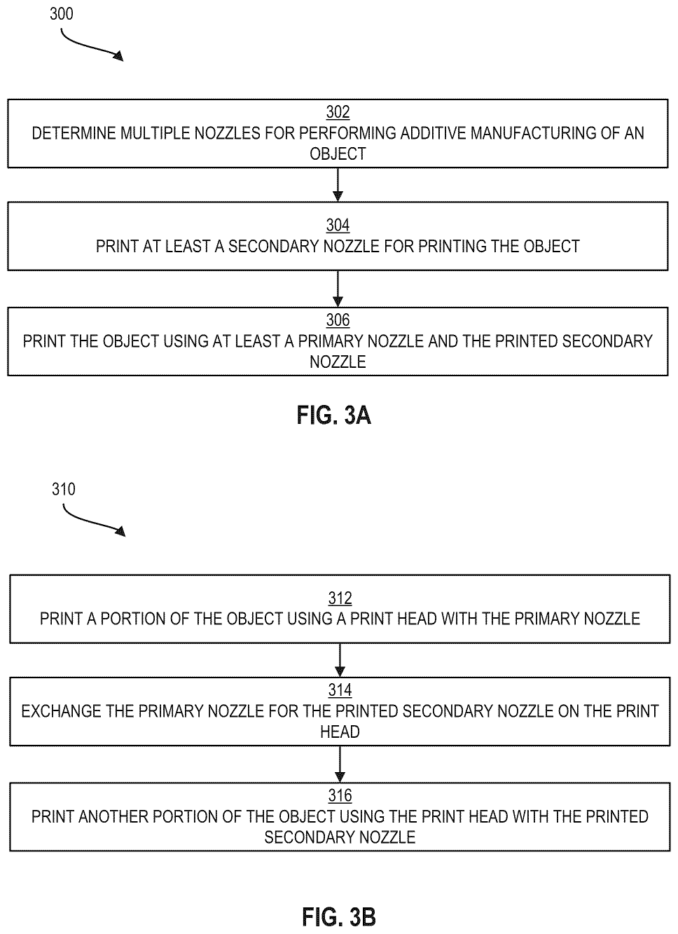

FIG. 3A illustrates a flowchart of an example method 300 for multi-nozzle 3D printing, in accordance with some embodiments of the present disclosure. The method 300 can be implemented by, for example, a 3D printer (e.g., 3D printer 100 of FIG. 1).

Operation 302 includes determining multiple nozzles for performing additive manufacturing of an object. Operation 302 can be based on manual input, automated selection, and/or output from a machine learning model. Of the multiple nozzles determined in operation 302, some may be pre-existing whereas others may not yet exist and need to be fabricated.

Operation 304 includes printing at least a secondary nozzle for printing the object. Operation 304 can utilize a dedicated nozzle print head for printing the secondary nozzle in a dedicated printing platform or a dedicated portion of a printing platform. In some embodiments, the secondary nozzle is printed concurrently with a portion of an object being printed, thereby reducing print time of the object. In some embodiments, the printed secondary nozzle exhibits different features from a first nozzle such as different orifice geometry (e.g., orifice size, orifice shape, orifice angle, etc.), different internal geometry (e.g., internal volume of the nozzle, internal geometries of the nozzle for manipulating rheological characteristics of the material, etc.), different external geometry (e.g., a curvature or extension to deposit material in an otherwise difficult-to-reach location), and the like.

Operation 306 includes printing the object using at least a primary nozzle and the printed secondary nozzle. Operation 306 can include exchanging the primary nozzle for the printed secondary nozzle as discussed in more detail hereinafter with respect to FIG. 3B.

FIG. 3B illustrates a flowchart of an example method 310 for exchanging nozzles during multi-nozzle 3D printing, in accordance with some embodiments of the present disclosure. The method 310 can be implemented by, for example, a 3D printer (e.g., 3D printer 100 of FIG. 1). The method 310 can be a sub-method of operation 306 of FIG. 3A.

Operation 312 includes printing a portion of the object using a print head with the primary nozzle. In some embodiments, operation 312 occurs concurrently with printing the secondary nozzle using the nozzle print head (e.g., see operation 304 of FIG. 3A).

Operation 314 includes exchanging the primary nozzle for the printed secondary nozzle on the print head. Operation 314 can be performed manually or automatically. When automatically performed, operation 314 can utilize a conveyer to detach the primary nozzle from the print head and affix the secondary nozzle to the print head. In embodiments where the secondary nozzle is retrofitted onto the primary nozzle, the conveyer can attach the secondary nozzle to the primary nozzle.

Operation 316 includes printing another portion of the object using the print head with the printed secondary nozzle. In some embodiments, the method 310 can repeat such that there are multiple exchanges of nozzles. In such embodiments, the primary nozzle and the secondary nozzle can be repeatedly exchanged in order to print different portions of the object. As another example, more than two nozzles can be used, and the method 310 can implement multiple nozzle exchanges where each exchange introduces a different nozzle.

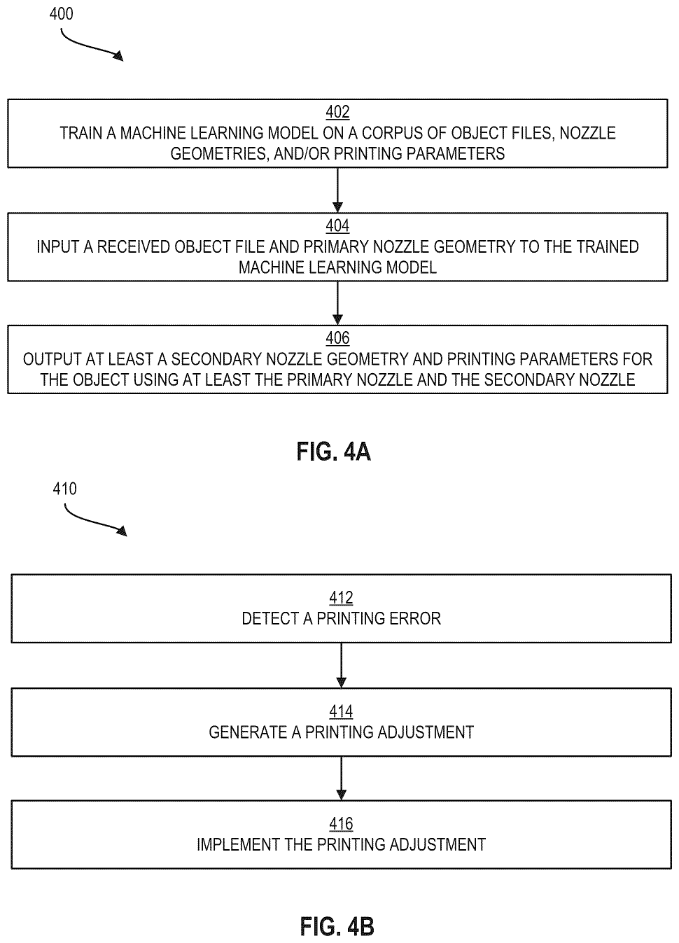

FIG. 4A illustrates a flowchart of an example method 400 for training a machine learning model for multi-nozzle 3D printing, in accordance with some embodiments of the present disclosure. The method 400 can be implemented by, for example, a 3D printer (e.g., 3D printer 100 of FIG. 1). The method 400 can be performed concurrently with the method 300 of FIG. 3A.

Operation 402 includes training a machine learning model on a corpus of object files, nozzle geometries, printing parameters, and/or printing outcomes (e.g., success or failure, a measure of quality, a measure of speed, etc.). Operation 402 can utilize any of the machine learning algorithms previously discussed with respect to the machine learning model 130 of FIG. 1.

Operation 404 includes inputting a received object file and primary nozzle geometry to the trained machine learning model. Operation 406 includes outputting at least a secondary nozzle geometry and printing parameters for the object using at least the primary nozzle and the secondary nozzle. In some embodiments, operation 406 outputs multiple additional nozzle geometries and printing parameters for printing the object using the primary nozzle and the multiple additional nozzle geometries.

FIG. 4B illustrates a flowchart of an example method 410 for correcting a printing error, in accordance with some embodiments of the present disclosure. The method 410 can be implemented by, for example, a 3D printer (e.g., 3D printer 100 of FIG. 1). The method 410 can be a sub-method of operation 306 of FIG. 3A.

Operation 412 includes detecting a printing error. A printing error can be, for example, an out-of-tolerance dimension of an object being printed, a defect of an object being printed (e.g., a defect caused by poor layer adhesion, poor material flow from the nozzle, a vibration or impact experienced by a 3D printer during printing, and the like), or another printing error related to dimensional and/or aesthetic properties of the object being printed. The printing error can be detected using one or more sensors arranged around the printing platform and monitoring printing of the object.

Operation 414 includes generating a printing adjustment. The printing adjustment can include repeating one or more previous trajectories of the print head (e.g., for redoing an area of the object subject to the printing error), creating a new print head trajectory (e.g., for ameliorating the print error), or another printing adjustment. In some embodiments, operation 414 can include generating instructions for printing a new nozzle for correcting the printing error.

Operation 416 includes implementing the printing adjustment. Operation 416 can cause the print head to perform the printing adjustment. If operation 414 determined a new nozzle is needed to correct the printing error, operation 416 can cause the nozzle print head to print the new secondary nozzle, cause the conveyer to exchange the new secondary nozzle with a nozzle on the print head, and cause the print head to implement the printing adjustment using the new secondary nozzle.

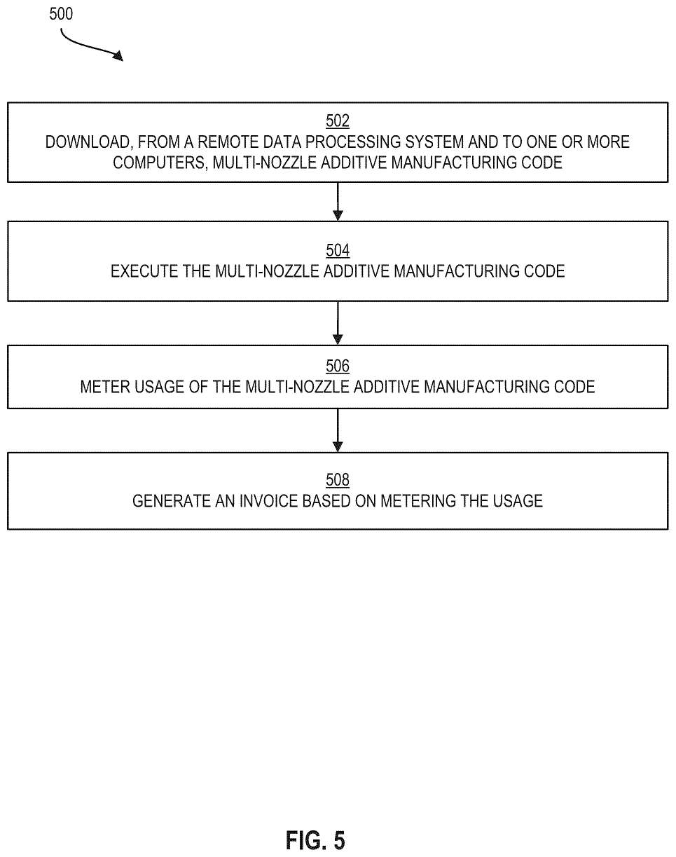

FIG. 5 illustrates a flowchart of an example method 500 for downloading, deploying, metering, and billing usage of multi-nozzle additive manufacturing code, in accordance with some embodiments of the present disclosure. The method 500 can be implemented by, for example, a 3D printer (e.g., 3D printer 100 of FIG. 1). The method 500 can be performed concurrently with the method 300 of FIG. 3A.

Operation 502 includes downloading, from a remote data processing system and to one or more computers (e.g., 3D printer 100 of FIG. 1) multi-nozzle additive manufacturing code. Operation 504 includes executing the multi-nozzle additive manufacturing code. Operation 504 can include performing any of the methods and/or functionalities discussed herein. Operation 506 includes metering usage of the multi-nozzle additive manufacturing code. Usage can be metered by, for example, an amount of time the multi-nozzle additive manufacturing code is used, a number of servers and/or devices deploying the multi-nozzle additive manufacturing code, an amount of resources consumed by implementing the multi-nozzle additive manufacturing code, a number of nozzles and/or objected printed using the multi-nozzle additive manufacturing code, and/or other usage metering metrics. Operation 508 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 illustrates a block diagram of an example computing environment, in accordance with some embodiments of the present disclosure. Computing environment 600 contains an example of an environment for the execution of at least some of the computer code involved in performing the inventive methods, such as multi-nozzle additive manufacturing code 646. In addition to multi-nozzle additive manufacturing code 646, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and multi-nozzle additive manufacturing code 646, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in multi-nozzle additive manufacturing code 646 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in multi-nozzle additive manufacturing code 646 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a three-dimensional printer. The three-dimensional printer comprises a primary print head with a primary nozzle; a nozzle print head configured to print different nozzles for additive manufacturing of an object; a secondary nozzle printed by the nozzle print head; and wherein the three-dimensional printer is configured to print the object using the primary print head, the primary nozzle, and the secondary nozzle.

Example 2 includes the features of Example 1. In this example, the three-dimensional printer further includes a first material for performing additive manufacturing of objects using the primary print head; a second material for performing additive manufacturing of nozzles using the nozzle print head; and wherein the second material has a higher melting temperature than the first material.

Example 3 includes the features of any one of Examples 1 to 2. In this example, the three-dimensional printer further includes a conveyer for exchanging the primary nozzle and the secondary nozzle on the primary print head.

Example 4 includes the features of any one of Examples 1 to 3. In this example, the three-dimensional printer further includes a computer-readable storage medium that is communicatively coupled to the three-dimensional printer, wherein the computer-readable storage medium stores a machine learning model configured to receive as input characteristics of the object and characteristics of the primary print head and generate as output characteristics of the secondary nozzle, and wherein the secondary nozzle is printed by the nozzle print head according to the characteristics of the secondary nozzle generated from the machine learning model.

Example 5 is a computer-implemented method. The computer-implemented method includes determining multiple nozzles for performing additive manufacturing of an object; printing, using a nozzle print head of a three-dimensional printer comprising a primary print head with a primary nozzle and the nozzle print head, a secondary nozzle; and printing the object using the primary print head, the primary nozzle, and the printed secondary nozzle.

Example 6 includes the features of Example 5. In this example, the primary nozzle is used to print a first portion of the object, and wherein the printed secondary nozzle is used to print a second portion of the object.

Example 7 includes the features of Example 6. In this example, printing the secondary nozzle using the nozzle print head occurs concurrently with printing the first portion of the object using the primary print head with the primary nozzle.

Example 8 includes the features of any one of Examples 5 to 7. In this example, printing the object using the primary print head, the primary nozzle, and the printed secondary nozzle comprises: exchanging the primary nozzle with the secondary nozzle in the primary print head.

Example 9 includes the features of Example 8. In this example, the exchanging utilizes a conveyer coupled to the three-dimensional printer.

Example 10 includes the features of any one of Examples 5 to 9. In this example, the printed secondary nozzle is retrofitted onto the primary nozzle to modify nozzle characteristics of the primary nozzle.

Example 11 includes the features of any one of Examples 5 to 10. In this example, the object comprises a first material with a first melting temperature, and wherein the printed secondary nozzle comprises a second material with a second melting temperature that is larger than the first melting temperature.

Example 12 includes the features of any one of Examples 5 to 11. In this example, the determining multiple nozzles for performing the additive manufacturing of the object comprises: inputting characteristics of the object and characteristics of the primary nozzle into a machine learning model; receiving, as output from the machine learning model, characteristics of the secondary nozzle; and wherein the printing the secondary nozzle using the nozzle print head is based on the characteristics of the secondary nozzle received from the machine learning model.

Example 13 is a system. The system includes one or more computer readable storage media storing program instructions; and one or more processors which, in response to executing the program instructions, are configured to perform a method according to any one of Examples 5 to 12, including or excluding optional features.

Example 14 is a computer program product. The computer program product includes one or more computer readable storage media, and program instructions collectively stored on the one or more computer readable storage media, the program instructions comprising instructions configured to cause one or more processors to perform a method according to any one of Examples 5 to 12, including or excluding optional features.

What is claimed is:

1. A three-dimensional printer comprising:
a primary print head with a primary nozzle;
a nozzle print head configured to print different nozzles for additive manufacturing of an object;
a secondary nozzle printed by the nozzle print head; and
wherein the three-dimensional printer is configured to print the object using the primary print head, the primary nozzle, and the secondary nozzle.

2. The three-dimensional printer of claim 1, further comprising:
a first material for performing additive manufacturing of objects using the primary print head;
a second material for performing additive manufacturing of nozzles using the nozzle print head; and
wherein the second material has a higher melting temperature than the first material.

3. The three-dimensional printer of claim 1, further comprising:
a conveyer for exchanging the primary nozzle and the secondary nozzle on the primary print head.

4. The three-dimensional printer of claim 1, further comprising:
a computer-readable storage medium that is communicatively coupled to the three-dimensional printer, wherein the computer-readable storage medium stores a machine learning model configured to receive as input characteristics of the object and characteristics of the primary print head and generate as output characteristics of the secondary nozzle, and wherein the secondary nozzle is printed by the nozzle print head according to the characteristics of the secondary nozzle generated from the machine learning model.

5. A computer-implemented method comprising:
determining multiple nozzles for performing additive manufacturing of an object;
printing, using a nozzle print head of a three-dimensional printer comprising a primary print head with a primary nozzle and the nozzle print head, a secondary nozzle; and
printing the object using the primary print head, the primary nozzle, and the printed secondary nozzle.

6. The method of claim 5, wherein the primary nozzle is used to print a first portion of the object, and wherein the printed secondary nozzle is used to print a second portion of the object.

7. The method of claim 6, wherein printing the secondary nozzle using the nozzle print head occurs concurrently with printing the first portion of the object using the primary print head with the primary nozzle.

8. The method of claim 5, wherein printing the object using the primary print head, the primary nozzle, and the printed secondary nozzle comprises:
exchanging the primary nozzle with the secondary nozzle in the primary print head.

9. The method of claim 8, wherein the exchanging utilizes a conveyer coupled to the three-dimensional printer.

10. The method of claim 5, wherein the printed secondary nozzle is retrofitted onto the primary nozzle to modify nozzle characteristics of the primary nozzle.

11. The method of claim 5, wherein the object comprises a first material with a first melting temperature, and wherein the printed secondary nozzle comprises a second material with a second melting temperature that is larger than the first melting temperature.

12. The method of claim 5, wherein determining multiple nozzles for performing the additive manufacturing of the object comprises:
inputting characteristics of the object and characteristics of the primary nozzle into a machine learning model;
receiving, as output from the machine learning model, characteristics of the secondary nozzle; and
wherein the printing the secondary nozzle using the nozzle print head is based on the characteristics of the secondary nozzle received from the machine learning model.

13. A computer program product comprising one or more computer readable storage media, and program instructions collectively stored on the one or more computer readable storage media, the program instructions comprising instructions configured to cause one or more processors to perform a method comprising:
determining multiple nozzles for performing additive manufacturing of an object;
printing, using a nozzle print head of a three-dimensional printer comprising a primary print head with a primary nozzle and the nozzle print head, a secondary nozzle; and
printing the object using the primary print head, the primary nozzle, and the printed secondary nozzle.

14. The computer program product of claim 13, wherein the primary nozzle is used to print a first portion of the object, and wherein the printed secondary nozzle is used to print a second portion of the object.

15. The computer program product of claim 14, wherein printing the secondary nozzle using the nozzle print head occurs concurrently with printing the first portion of the object using the primary print head with the primary nozzle.

16. The computer program product of claim 13, wherein printing the object using the primary print head, the primary nozzle, and the printed secondary nozzle comprises:
exchanging the primary nozzle with the secondary nozzle in the primary print head.

17. The computer program product of claim 16, wherein the exchanging utilizes a conveyer coupled to the three-dimensional printer.

18. The computer program product of claim 13, wherein the printed secondary nozzle is retrofitted onto the primary nozzle to modify nozzle characteristics of the primary nozzle.

19. The computer program product of claim 13, wherein the object comprises a first material with a first melting temperature, and wherein the printed secondary nozzle comprises a second material with a second melting temperature that is larger than the first melting temperature.

20. The computer program product of claim 13, wherein determining multiple nozzles for performing the additive manufacturing of the object comprises:
inputting characteristics of the object and characteristics of the primary nozzle into a machine learning model;
receiving, as output from the machine learning model, characteristics of the secondary nozzle; and
wherein the printing the secondary nozzle using the nozzle print head is based on the characteristics of the secondary nozzle received from the machine learning model.
